(19) United States
(12) Patent Application Publication
(10) Pub. No.: US 2002/0157040 A1
(43) Pub. Date: Oct. 24, 2002

(54) Program-controlled unit and method of operating the program-controlled unit

(76) Inventors: Jens Barrenscheen, Munchen (DE); Karl Herz, Munchen (DE); Gunther Fenzl, Hohenkirchen (DE); Wilhard Von Wendorff, Munchen (DE); Oliver Winkler, Augsburg (DE); Sven Wenzek, Mulheim A.D. Ruhr (DE); Michael Zimmermann, Essen (DE)

Correspondence Address: LERNER AND GREENBERG, P.A., Post Office Box 2480, Hollywood, FL, 33022-2480, US

(21) Appl. No.: 10/116,155

(22) Filed: Apr. 4, 2002

(30) Foreign Application Priority Data
Apr. 4, 2001 (DE) 101 16 865.9

(51) Int. Cl. H02H 3/05

(52) U.S. Cl. 714/28

(57) ABSTRACT

A program-controlled unit is described and is distinguished in that it has a connection which can be used to signal to it whether it is connected to a particular other circuit, and/or in that the program-controlled unit has a connection which it can use to signal to an external device that it is currently communicating or cooperating with a particular other device. Such a program-controlled unit can communicate and cooperate with devices connected to it better than has been the case to date, but at the same time can operate correctly under all circumstances even without these devices.

### BACKGROUND OF THE INVENTION

### FIELD OF THE INVENTION

The present application relates to a program-controlled unit.

Program-controlled units such as microprocessors, microcontrollers, signal processors etc. have been known for many years in countless forms and require no more detailed explanation.

A known problem of program-controlled units is that it is frequently not a simple matter to identify, locate and eliminate faults which arise.

Often, an “emulator” is used for this purpose. An emulator is able to identify the occurrence of prescribable states or events and to react to the occurrence of the state or event in question in a manner that can likewise be prescribed.

The prescribable states or events involve, by way of example, particular data, addresses or control signals being transferred or having been stored within or outside the program-controlled unit.

The prescribable reactions to the occurrence of such or other states or events include, by way of example, stopping the program-controlled unit, reading and/or altering the contents of registers or internal or external memories, and/or recording and evaluating previously and/or subsequently occurring profiles of significant data, addresses, signals and/or register and memory contents.

It is known that program-controlled units used in mass-produced products (and referred to below as the mass-produced version of the program-controlled unit for the sake of simplicity) cannot generally be used in emulators because the emulators provide only limited opportunity for access to the significant data, addresses, signals, registers and memories, and because they cannot monitor and record the occurrence of the significant states and events in real time.

Hence, more complex program-controlled units, in particular, are produced in special versions that permit the aforementioned access operations and can therefore be used in emulators. The special versions of the program-controlled units are referred to below as emulation versions.

### SUMMARY OF THE INVENTION

It is accordingly an object of the invention to provide a program-controlled unit and a method for operating the program-controlled unit that overcome the above-mentioned disadvantages of the prior art devices and methods of this general type, which operates correctly under all circumstances both on its own and in interaction with other circuits.

With the foregoing and other objects in view there is provided, in accordance with the invention, a program-controlled unit. The program-controlled unit contains a connection for signaling if the program-controlled unit is connected to a particular other circuit.

The program-controlled unit according to the invention is distinguished in that the program-controlled unit has a connection which can be used to signal to the program-controlled unit whether the program-controlled unit is connected to a particular other circuit, and/or in that the program-controlled unit has a connection which it can use to signal to an external device that it is currently communicating or co-operating with a particular other device.

A program-controlled unit configured in this mannered reliably makes it possible to prevent:

a) the program-controlled unit from attempting to access a system component which is not present;

b) the program-controlled unit from reacting to data which appear to come from a system component which is not actually present;

c) the program-controlled unit from being able to communicate or cooperate incorrectly with a system component which is connected to it because access operations by the program-controlled unit to the (first) system component collide with access operations by a second system component to the first system component; and

d) information which the program-controlled unit writes to the first system component and/or which the first system component has stored via the program-controlled unit from:

e) not being fetched and evaluated by the second system component before the information is complete and/or valid;

f) not being fetched and evaluated by the second system component if the information might no longer be current or might no longer be valid; and/or

g) being fetched and evaluated immediately by the second system component as soon as the information is complete and/or valid.

Program-controlled units configured as described are certain to operate correctly both on their own and in interaction with other circuits.

In accordance with an added feature of the invention, the program-controlled unit assumes that it is connected to the particular other circuit if and for as long as a particular signal is supplied to the connection. The particular signal, which needs to be supplied to the program-controlled unit for it to assume that it is connected to the particular other circuit, has a voltage level which is permanently high or permanently low. If the program-controlled unit does not appear to be connected to the particular other circuit, the program-controlled unit does not attempt to communicate or cooperate with the particular other circuit. If the program-controlled circuit does not appear to be connected to the particular other circuit, the program-controlled unit ignores data appearing to come from the particular other circuit.

In accordance with another feature of the invention, an interface which is reserved for an interchange of data between the program-controlled unit and the particular other circuit is provided. The interface does not forward data supplied to it if the program-controlled unit does not appear to be connected to the particular other circuit, and the interface is coupled to the connection.

In accordance with a further feature of the invention, precautions are taken which allow the program-controlled unit to evaluate not the particular signal which is supplied to it via the connection, but rather a further signal which is available within the program-controlled unit. The further signal indicates that the program-controlled unit is not connected to the particular other circuit.

With the foregoing and other objects in view there is provided, in accordance with the invention, a program-controlled unit. The program-controlled unit contains a connection for signaling to an external device that the program-controlled unit is currently communicating or cooperating with a particular other device.

In accordance with an added feature of the invention, the external device is a device communicating or cooperating with the particular other device. The particular other device is a device provided to emulate the program-controlled unit. The external device is a control unit controlling an emulation.

The program-controlled unit signals to the external device that it is communicating or cooperating with the particular other device when the program-controlled unit is performing read or write access to a memory device in the particular other device, which can also read from or write to the external device. The program-controlled unit signals to the external device that the program-controlled unit is communicating or cooperating with the particular other device if and for as long as the program-controlled unit is executing a program stored in the particular other device.

In accordance with a concomitant feature of the invention, the program-controlled unit signals to the external device that the program-controlled unit is communicating or cooperating with the particular other device if and for as long as the program-controlled unit is executing the program stored in the other device whose execution has been prompted by the program-controlled unit itself.

Other features which are considered as characteristic for the invention are set forth in the appended claims.

Although the invention is illustrated and described herein as embodied in a program-controlled unit and a method of operating the program-controlled unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a block diagram of a conventional mass-produced version of a program-controlled unit;

FIG. 1B is a block diagram of a conventional emulation version of the program-controlled unit;

FIG. 2 is a block diagram of an emulation version of the program-controlled unit according to the invention; and

FIG. 3 is a block diagram of the emulation version of the program-controlled unit that is shown in FIG. 2, in which some of the peculiarities of the program-controlled unit are illustrated in more detail.

### DESCRIPTION OF THE PREFERRED EMBODIMENTS

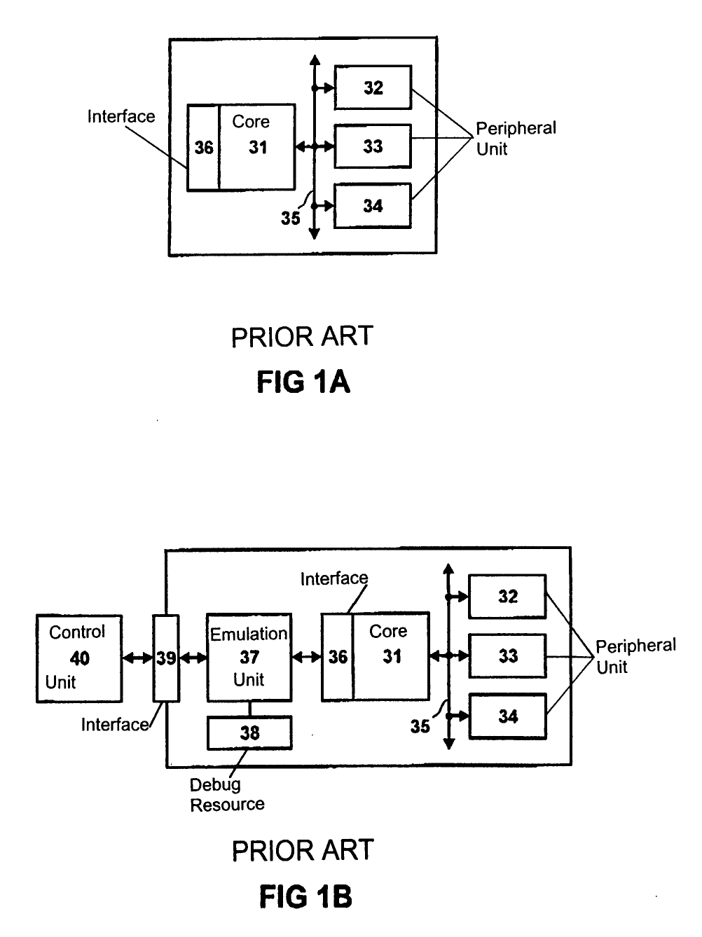

Referring now to the figures of the drawing in detail and first, particularly, to FIG. 1A thereof, there is shown a basic configuration of a mass-produced version of a program-controlled unit. FIG. 1B shows a configuration of an emulation version of the program-controlled unit shown in FIG. 1A.

The mass-produced version of the program-controlled unit, shown in FIG. 1A, contains a core 31, peripheral units 32, 33 and 34, such as a timer, A/D converter, memory, etc., and a bus 35 which connects the core 31 and the peripheral units 32, 33 and 34. The core 31 also contains an emulation interface 36 which can be used to connect an emulation unit provided in the emulation version of the program-controlled unit to the core 31.

The emulation version of the program-controlled unit, shown in FIG. 1B, contains the mass-produced version, that is to say likewise the core 31, the peripheral units 32, 33 and 34, the bus 35 and the emulation interface 36. Additional components required for emulating the mass-produced version are an emulation unit 37, debug resources 38 and an emulator interface 39 which can be used to connect the emulation unit 37 to a control unit 40 controlling the emulation.

The emulation unit 37 contains, by way of example, a “breakpoint” or “watchpoint” logic unit, which is necessary in order to set the states or events whose occurrence needs to be monitored and in order to identify the occurrence of the states or events which need to be monitored.

The debug resources 38 contain, by way of example, an “overlay memory”, which can store programs and/or data which need to be used during the emulation instead of the programs and/or data which are stored in the memory used normally, and a “monitor memory”, which stores debug sequences needing to be executed during the emulation.

Emulation versions of the type shown in FIG. 1B can (but do not have to) be multichip modules as described in Published, Non-Prosecuted German Patent Application DE 197 432 64, corresponding to U.S. patent application Ser. No. 09/164,118 for example.

In such multichip modules, the components which in the mass-produced version of the program-controlled unit, shown in FIG. 1A, and the components which are, in contrast, additionally contained in the emulation version of the program-controlled unit are accommodated on various chips, and the various chips are connected to one another in a suitable manner as required (when an emulation version of the program-controlled unit is produced).

Such a practice has the advantage that the complexity required for producing an emulation version of the program-controlled unit is limited to the development and production of a chip containing the components required for the emulation. The mass-produced version can also be used in the emulation version of the program-controlled unit without any, or at any rate any significant, changes.

However, particular precautions need to be taken which make it possible to ensure that the mass-produced version of the program-controlled unit operates correctly under all circumstances both on its own and in the emulation version. This problem has not been solved entirely satisfactorily to date.

Corresponding problems can also arise if the program-controlled unit needs to be able to cooperate with other circuits that are not always present. In this context, it makes no difference whether the circuits are accommodated on the same chip as the program-controlled unit or on another chip.

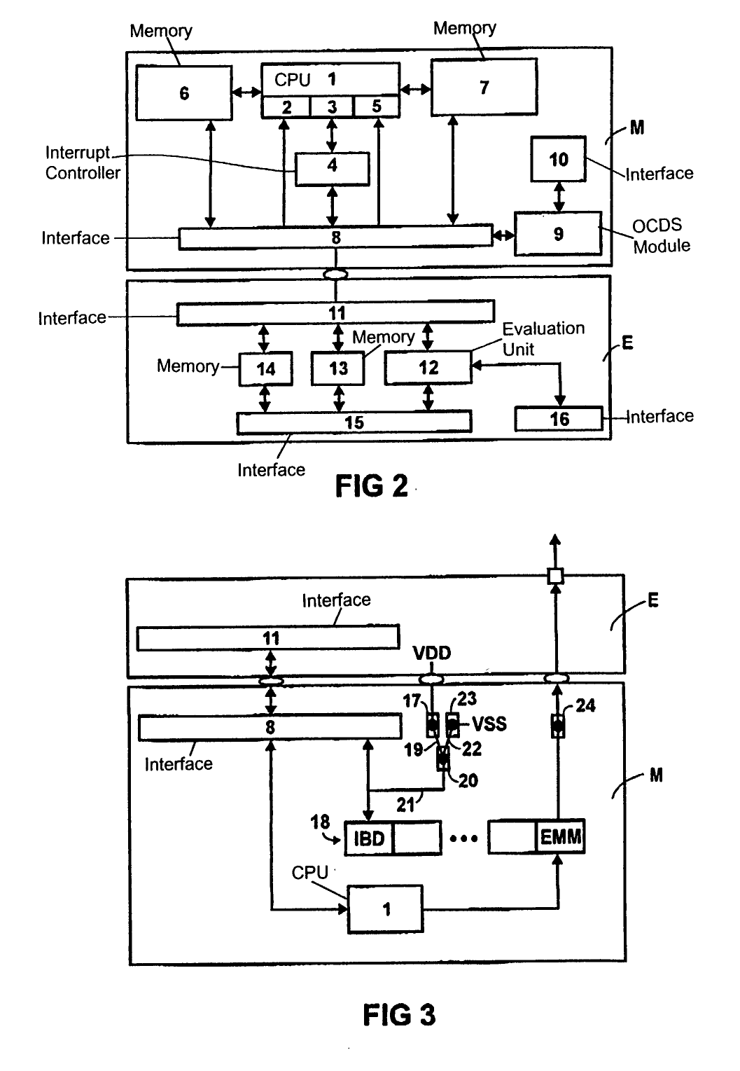

FIG. 2 shows the program-controlled unit according to the invention and contains a mass-produced part M and an emulation part E. The parts possibly being accommodated on the same semiconductor chip or on different semiconductor chips, and the mass-produced part M optionally being able to be used on its own (without the emulation part E, that is to say as a mass-produced version of the program-controlled unit) or together with the emulation part E (in the emulation version) of the program-controlled unit M.

The mass-produced part M contain a CPU 1 executing a program, a break circuit 2, connected to the CPU 1 or contained therein, for stopping the CPU 1, an inject circuit 3, connected to the CPU 1 or contained therein, and an interrupt controller 4, connected upstream of the inject circuit 3, for injecting commands which are not contained in the program to be executed by the CPU 1. A trace circuit 5 is connected to the CPU 1 or is contained therein and which can be used to prompt the storage of selected addresses, data, signals, memory and register contents in a trace memory normally accommodated in the emulation part. A program memory 6 is connected to the CPU 1, for storing a program that is to be executed by the CPU 1 during normal operation of the program-controlled unit. A data memory 7 is connected to the CPU 1 for storing data that are required for executing commands and are produced by the execution of commands. An emulation interface 8 is connected to the break circuit 2, to the interrupt controller 4, to the trace circuit 5, to the program memory 6 and to the data memory 7, for connecting the emulation part E to the mass-produced part M. An on chip debug support (OCDS) module 9 is connected to the emulation interface 8. An interface 10, which is formed by a JTAG interface in the example under consideration but can also be produced by another interface, which the OCDS module 9 can use to communicate with system components provided outside the program-controlled unit.

The emulation part E contains an emulation interface 11 for connecting the emulation part E to the mass-produced part M, an emulation unit 12 connected to the emulation interface 11, and a monitor memory 13, which is connected to the emulation interface 11 and stores programs (debug sequences, monitor programs) which are used for monitoring the mass-produced part M. An overlay memory 14 is connected to the emulation interface 11 and which the mass-produced part M can use as a program memory instead of the program memory 6. An emulator interface 15 is connected to the emulation unit 12, to the monitor memory 13 and to the overlay memory 14, for connecting the emulation part E to the control unit 40 that is provided outside the program-controlled unit and controls the emulation. A second interface 16 is connected to the emulation unit 12, and is formed by a JTAG interface in the example under consideration but can also be produced by another interface, and which the emulation unit 12 can use to communicate with system components provided outside the program-controlled unit, but whose configuration is different than that of the emulator interface 15.

The mass-produced part M of the program-controlled unit under consideration can be emulated in three different ways, namely:

a) using the JTAG interface 10, the OCDS module 9, the emulation interface 8 and the rest of the components on the mass-produced part M which are connected thereto;

b) using the JTAG interface 16, the emulation unit 12 and the emulation interface 11 in the emulation part E, and also the emulation interface 8 and the rest of the components on the mass-produced part M which are connected thereto; and

c) using the emulator interface 15, the emulation unit 12, the monitor memory 13, the overlay memory 14 and the emulation interface 11 in the emulation part E and also the emulation interface 8 and the rest of the components on the mass-produced part M which are connected thereto.

Option a) allows the mass-produced part M to be emulated to a certain restricted extent even without the emulation part E (the OCDS module 9 affords only restricted opportunities to emulate the mass-produced part M).

Option b) allows the mass-produced part M to be emulated more extensively and/or conveniently (the emulation unit 12 has a larger functional scope than the OCDS module 9, or additional emulation functions).

Option c) allows the mass-produced part M to be emulated even more extensively and/or conveniently (emulation can be effected additionally using the monitor memory 13, the overlay memory 14 and possibly other debug resources not shown in FIG. 2, such as a “trace memory”).

Besides the configuration described above, the program-controlled unit shown in FIG. 2 has a few peculiarities which are described in more detail below with reference to FIG. 3 and to FIG. 2, which has already been explained above.

One of these peculiarities is that the program-controlled unit, more precisely the mass-produced version or the mass-produced part M of the emulator version, has an input connection which can be used to signal to it whether the program-controlled unit is connected to a particular other circuit.

The signaling is preferably, but not necessarily, performed by the circuit whose presence is intended to be able to be identified thereby.

In the example under consideration, the circuit is the emulation part E of the program-controlled unit; however, the circuit may also be any other circuit (for example a memory or an A/D converter), with this circuit being able to be provided on the same chip as the program-controlled unit or on a chip other than that for the program-controlled unit.

An input connection 17 which can be used to signal the presence of the emulation part E to the mass-produced part M is shown in FIG. 3 and is referred to below as a detection connection 17.

Although not all the components of the program-controlled unit shown in FIG. 2 are shown in FIG. 3, the program-controlled unit shown in FIG. 3 corresponds to the program-controlled unit shown in FIG. 2.

In the example under consideration, the detection connection 17 is a pad on the mass-produced part M which is connected to a non-illustrated associated connection on the emulation part E (provided that an emulation part E is present) and which is connected within the mass-produced part M to the emulation interface 8 and to a memory element IBD of an emulation control memory 18, which memory element IBD indicates the status of the detection connection 17. The connection to the emulation interface 8 and to the memory element IBD is produced by a bonding wire 19, which connects the detection connection 17 to a further pad 20, and by a line 21, with the further pad 20 optionally being connected to the detection connection 17 by the bonding wire 19 or to a pad 23 (referred to below as the deactivation pad) on the mass-produced part M by a bonding wire 22. The deactivation pad 23 has a potential applied to it permanently, and irrespective of whether or not the emulation part E is connected, whose evaluation gives the result that no emulation part E is connected to the mass-produced part M.

In the example under consideration, the mass-produced part M assumes that an emulation part E is connected when the potential VDD is supplied to the pad 20. In this case, the deactivation pad 23 has the potential VSS applied to it.

For the sake of completeness, it should be noted that VDD and VSS can also be interchanged, and that any other potentials can also be used instead of VDD and VSS. The signals that signal whether or not an emulation part E is connected to the mass-produced part M are preferably static signals, i.e. signals that have a particular level permanently. This makes it a particularly simple matter to establish whether or not an emulation part E is connected to the mass-produced part M.

If the mass-produced part M, more precisely the pad 20 thereon, has a signal supplied to it which signals that there is no emulation part E connected to the mass-produced part M, the mass-produced part M ignores data which come or appear to come from the emulation part E, and/or refrains from outputting data to the emulation part E. In the example under consideration, this is done by appropriate driving of the emulation interface 8 and by a non-illustrated latching mechanism which enables or blocks access operations to the emulation part E on the basis of the content of the emulation control memory 18, more precisely on the basis of the content of the latter's element IBD.

In the other case, i.e. when the mass-produced part M, more precisely the pad 20 thereon, has a signal supplied to it which signals that an emulation part E is connected to the mass-produced part M, the mass-produced part M and the emulation part E can communicate and cooperate correctly.

The fact that the pad 20 can optionally be connected to the detection connection 17 or to the deactivation pad 23 results in that it is possible to stipulate in the mass-produced part M whether it needs to be able to communicate and cooperate with an emulation part E. Connection of the pad 20 to the deactivation pad 23 allows the mass-produced part M to be reliably prevented, when required, from being able to communicate and cooperate with a device connected to the emulation interface 8. This makes it possible to prevent secret data stored in the mass-produced part M from being able to be read out by exposing the chip and tapping the emulation interface 8.

For the sake of completeness, it should be noted that the emulation control memory 18 contains not only the element IBD but also further elements, which store or buffer-store information that can be used for the emulation and/or the communication and/or cooperation with the emulation part E.

Another peculiarity of the program-controlled unit under consideration here is that the program-controlled unit has a connection which it can use to signal to the emulator that it is accessing the emulation part E or—expressed in more general terms and for any other system configurations—that the program-controlled unit has a connection which it can use to signal to an external device that it is currently communicating or cooperating with a particular other device connected to it.

In FIG. 3, the connection is a pad denoted by the reference symbol 24 and is referred to below as the access indicator pad 24.

The access indicator pad 24 is connected to a non-illustrated pad on the emulation part E and is supplied by the emulation part E to the control unit 40 connected thereto. For the sake of completeness, it should be pointed out that this signal does not have to be supplied to the control unit via the emulation part E. This signal could also be transmitted to the control unit via a connection on the mass-produced part M that is directly connected to the control unit.

The access indicator pad 24 is connected within the mass-produced part M to a memory element EMM of the emulation control memory 18. The memory element EMM has information written to it by a logic unit that detects whether the mass-produced part M is accessing the emulation part E.

In the example under consideration, the access indicator pad 24 is used to signal to the control unit when the mass-produced part M is accessing a component on the emulation part E to which the control unit also has access.

The access operations by the mass-produced part M to the emulation part E which are signaled to the control unit can exclusively be such access operations as occur at the mass-produced part's own prompting or whose time is not known to the control unit. Alternatively, other or all access operations can be signaled.

Access signaling is found to be advantageous because it allows the program-controlled unit to synchronize the control unit controlling the emulation. Therefore, it is possible to prevent the control unit from deleting or overwriting data stored in the emulation part which the mass-produced part M might still need or will still need, and prevent the control unit from reading and evaluating data stored in the emulation part or in the mass-produced part before the data to be evaluated have been stored there or after the data to be evaluated have already been deleted or overwritten again or if the data are already obsolete.

This can be achieved, by way of example, by virtue of the mass-produced part M using a rising edge in the signal which is output via the access indicator pad 24 to signal that it has started to access the emulation part E, and by virtue of the mass-produced part M using a falling edge in the signal which is output via the access indicator pad 24 to signal that it has ended access to the emulation part E (or vice versa). The control unit can then tell from the rising edge (at the high level) of the signal that for the time being (up until the falling edge) it must not erase or overwrite any data, or can erase or overwrite only certain data, in the emulation part, and that data which it subsequently reads from the emulation part and evaluates are possibly not yet or no longer the data which are actually to be evaluated. The control unit can tell from the falling edge (at the low level) of the signal that it can now delete and overwrite data in the program-controlled unit again and/or that it should or needs to start reading and evaluating data stored in the program-controlled unit immediately or soon.

This makes it possible for the application program to prompt execution of a debug sequence stored in the monitor memory 13 in order, by way of example, to read or alter register or memory contents, which is necessary for emulation purposes. The execution of programs stored in the monitor memory 13 has been prompted exclusively by the control unit up to now. The fact that this can now also be done by the application program as a result of the measures mentioned above results in that it is also possible to emulate program-controlled units in which the interruption to the application program, which interruption is necessary in order to execute a program stored in the monitor memory 13, must be effected only in quite particular (non-time-critical) phases of the application program, otherwise the application being examined is disrupted such that the system containing the program-controlled unit no longer behaves as in normal operation.

Without the access signaling described or any comparable access signaling, this would not be possible, because the control unit would in this case naturally have no information about when it can or needs to access the program-controlled unit in order to perform the tasks assigned to it. Access signaling therefore opens up quite new opportunities for emulating program-controlled units.

The program that prompts execution of a program stored in the monitor memory 13 can (but does not have to) be a program which is stored in the overlay memory 14 and whose execution has been prompted by the emulator. The program is a program that has been produced as a result of a modification to the application program executed in normal operation. The modified application program stored in the overlay memory corresponds to the application program executed in normal operation, but contains calls to debug sequences from the monitor memory at points that are not critical in time.

Independently of this, the emulation part of the program-controlled unit contains a mechanism that prevents simultaneous access operations by the mass-produced part M and by the control part to the same component on the emulation part. In the example under consideration, access by the mass-produced part M has priority. This can naturally also be the other way round or can vary from component to component.

In addition, the emulation part E of the program-controlled unit can contain a mechanism that prevents the mass-produced part from accessing the monitor memory. This makes it possible to prevent a program that is not running correctly from overwriting the monitor memory and hence becoming totally uncontrollable. The mechanism can be contained, by way of example, in the emulation interface of the emulation part and can prevent write access to the memory area occupied by the monitor memory.

A further protective mechanism of the program-controlled unit under consideration can involve the output drivers of a trace memory contained in the program-controlled unit being able to be turned off. This makes it possible to prevent programs that need to be kept secret and are stored in the program-controlled unit from being able to be read via the control unit.

A program-controlled unit configured as described can, irrespective of the details of the practical implementation, communicate and cooperate with devices connected thereto better than has been the case to date, but at the same time can operate correctly under all circumstances even without these devices.

We claim:

1. A program-controlled unit, comprising:
a connection for signaling if the program-controlled unit is connected to a particular other circuit.

2. The program-controlled unit according to claim 1, wherein the program-controlled unit assumes that it is connected to the particular other circuit if and for as long as a particular signal is supplied to said connection.

3. The program-controlled unit according to claim 2, wherein the particular signal, which needs to be supplied to the program-controlled unit for it to assume that it is connected to the particular other circuit, has a voltage level which is one of permanently high and permanently low.

4. The program-controlled unit according to claim 1, wherein if the program-controlled unit does not appear to be connected to the particular other circuit, the program-controlled unit does not attempt to communicate or cooperate with the particular other circuit.

5. The program-controlled unit according to claim 1, wherein if the program-controlled circuit does not appear to be connected to the particular other circuit, the program-controlled unit ignores data appearing to come from the particular other circuit.

6. The program-controlled unit according to claim 1, further comprising an interface which is reserved for an interchange of data between the program-controlled unit and the particular other circuit, said interface does not forward data supplied to it if the program-controlled unit does not appear to be connected to the particular other circuit, and said interface is coupled to said connection.

7. The program-controlled unit according to claim 2, wherein precautions are taken which allow the program-controlled unit to evaluate not the particular signal which is supplied to it via said connection, but rather a further signal which is available within the program-controlled unit.

8. The program-controlled unit according to claim 7, wherein the further signal indicates that the program-controlled unit is not connected to the particular other circuit.

9. A program-controlled unit, comprising:
a connection for signaling to an external device that the program-controlled unit is currently communicating or cooperating with a particular other device.

10. The program-controlled unit according to claim 9, wherein the external device is a device communicating or cooperating with the particular other device.

11. The program-controlled unit according to claim 9, wherein the particular other device is a device provided to emulate the program-controlled unit.

12. The program-controlled unit according to claim 9, wherein the external device is a control unit controlling an emulation.

13. The program-controlled unit according to claim 9, wherein the program-controlled unit signals to the external device that it is communicating or cooperating with the particular other device when the program-controlled unit is performing read or write access to a memory device in the particular other device, which can also read from or write to the external device.

14. The program-controlled unit according to claim 13, wherein the program-controlled unit signals to the external device that the program-controlled unit is communicating or cooperating with the particular other device if and for as long as the program-controlled unit is executing a program stored in the particular other device.

15. The program-controlled unit according to claim 14, wherein the program-controlled unit signals to the external device that the program-controlled unit is communicating or cooperating with the particular other device if and for as long as the program-controlled unit is executing the program stored in the other device whose execution has been prompted by the program-controlled unit itself.

16. A method for operating an apparatus, which comprises the step of:
providing a program-controlled unit with a connection for signaling if the program-controlled unit is connected to a particular other circuit.

17. The method according to claim 16, which comprises assuming the program-controlled unit is connected to the particular other circuit if and for as long as a particular signal is supplied to the connection.

18. The method according to claim 17, which comprises providing the particular signal to have a voltage level which is one of permanently high and permanently low.

19. The method according to claim 16, which comprises not attempting to communicate or cooperate with the particular other circuit if the program-controlled unit does not appear to be connected to the particular other circuit.

20. The method according to claim 16, which comprises ignoring data appearing to come from the particular other circuit if the program-controlled unit does not appear to be connected to the particular other circuit.

21. The method according to claim 16, which comprises providing an interface which is reserved for an interchange of data between the program-controlled unit and the particular other circuit, and the interface does not forward the data supplied to it if the program-controlled unit does not appear to be connected to the particular other circuit.

22. The method according to claim 17, which comprises taking precautions which allow the program-controlled unit to evaluate not the particular signal which is supplied to it through the connection, but rather a further signal which is available within the program-controlled unit.

23. The method according to claim 22, which comprises setting up the further signal to indicate that the program-controlled unit is not connected to the particular circuit.

24. A method for operating an apparatus, which comprises the step of:
providing a program-controlled unit with a connection for signaling to an external device that the program-controlled unit is currently communicating or cooperating with a particular other device.

25. The method according to claim 24, which comprises forming the external device as a device for communicating or cooperating with the particular other device.

26. The method according to claim 24, which comprises forming the particular other device as a device for emulating the program-controlled unit.

27. The method according to claim 24, which comprises forming the external device as a control unit controlling an emulation.

28. The method according to claim 24, which comprises signaling from the program-controlled unit to the external device that the program-controlled unit is communicating or cooperating with the particular other device when it is performing read or write access to a memory device in the particular other device, which can also read from or write to the external device.

29. The method according to claim 28, which comprises signaling from the program-controlled unit to the external device that the program-controlled unit is communicating or cooperating with the particular other device if and for as long as the program-controlled unit is executing a program stored in the particular other device.

30. The method according to claim 29, which comprises signaling from the program-controlled unit to the external device that the program-controlled unit is communicating or cooperating with the particular other device if and for as long as the program-controlled unit is executing a program stored in the other device whose execution has been prompted by the program-controlled unit itself.

31. A program-controlled unit, comprising:
a connection for signaling if the program-controlled unit is connected to a particular other circuit; and
an emulation control memory coupled to said connection, said emulation control memory indicating a status of said connection.

32. A program-controlled unit, comprising:
a connection for signaling to an external device that the program-controlled unit is currently communicating or cooperating with a particular other device; and
a CPU coupled to said connection.
